(19) United States
(12) Patent Application Publication
(10) Pub. No.: US 2025/0252776 A1
(43) Pub. Date: Aug. 7, 2025

(54) INFORMATION PROCESSING SYSTEM, INFORMATION PROCESSING METHOD, AND NON-TRANSITORY RECORDING MEDIUM

(71) Applicant: NEC Corporation, Minato-ku, Tokyo (JP)

(72) Inventor: Kazuo TSUGE, Tokyo (JP)

(73) Assignee: NEC Corporation, Minato-ku, Tokyo (JP)

(21) Appl. No.: 18/855,049

(22) PCT Filed: Sep. 13, 2022
(86) PCT No.: PCT/JP2022/034160

§ 371 Date: Oct. 8, 2024

(51) Int. Cl. G06V 40/16; G06T 1/20

(52) U.S. Cl. CPC G06V 40/172; G06T 1/20; G06V 40/168

(57) ABSTRACT

An information processing system includes: an acquisition unit that sequentially acquires face information on a face area detected from captured images sequentially captured; a storage unit that sequentially stores the acquired face information; an extraction unit that performs an extraction operation of extracting a feature quantity from each piece of face information that is at least a part serving as an extraction target, of pieces of face information stored in the storage unit, in a case where a predetermined condition is satisfied; and an authentication unit that performs face authentication using the feature quantity.

### TECHNICAL FIELD

This disclosure relates to technical fields of an information processing system, an information processing method, and a recording medium.

### BACKGROUND ART

Patent Literature 1 describes a technique/technology of: including a plurality of image input units to which images are inputted; detecting, by a detection unit, an object region from an image inputted from the image input unit; extracting a feature quantity from the image of the object region detected by the detection unit; controlling detection processing and feature extraction processing that are performed on images inputted by the plurality of image input units, based on a detection result of the object region by the detection unit; and performing monitoring.

Patent Literature 2 describes a technique/technology of: acquiring object information on at least one object for each frame image in a video; monitoring a processing load of an image processing apparatus; selecting the object information on a verification target on the basis of the processing load; calculating a feature quantity by using the selected object information; and performing verification by using the feature quantity, thereby collating/verifying objects in a video with a database.

Patent Literature 3 describes a verification device used in a gate equipped with a restriction unit that restricts a flow of people, the verification device including: a processing unit that performs, in a path in which there is a flow of people from a first area to a second area located upstream of the restriction unit, second face image verification using a first candidate face image that has been narrowed down by a result of first face image verification using a first image obtained by imaging the first area, and a second image obtained by imaging the second area; and a communication unit that outputs a result of the second face image verification.

Patent Literature 4 describes a technique/technology of: detecting a subject that is a target of subject collation/verification from an image; identifying a method used in the subject collation/verification to the subject from a plurality of methods; determining whether or not the subject satisfies a predetermined condition according to the identified method; selecting an image of the subject determined to satisfy the predetermined condition; and transmitting the selected image of the subject to an external device that is configured to perform the subject collation/verification.

### CITATION LIST

### Patent Literature

Patent Literature 1: JP2011-070576A
Patent Literature 2: JP2020-009383A
Patent Literature 3: JP2021-131606A
Patent Literature 4: JP2022-026846A

### SUMMARY

### Technical Problem

It is an example object of this disclosure to provide an information processing system, an information processing method, and a recording medium that aim to improve the techniques/technologies disclosed in Citation List.

### Solution to Problem

An information processing system according to an example aspect includes: an acquisition unit that sequentially acquires face information on a face area detected from captured images sequentially captured; a storage unit that sequentially stores the acquired face information; an extraction unit that performs an extraction operation of extracting a feature quantity from each piece of face information that is at least a part serving as an extraction target, of pieces of face information stored in the storage unit, in a case where a predetermined condition is satisfied; and an authentication unit that performs face authentication using the feature quantity.

An information processing method according to an example aspect includes: sequentially acquiring face information on a face area detected from captured images sequentially captured; sequentially storing the acquired face information in a storage unit; performing an extraction operation of extracting a feature quantity from each piece of face information that is at least a part serving as an extraction target, of pieces of face information stored in the storage unit, in a case where a predetermined condition is satisfied; and performing face authentication using the feature quantity.

A recording medium according to an example aspect is a recording medium on which a computer program that allows a computer to execute an information processing method is recorded, the information processing method including: sequentially acquiring face information on a face area detected from captured images sequentially captured; sequentially storing the acquired face information in a storage unit; performing an extraction operation of extracting a feature quantity from each piece of face information that is at least a part serving as an extraction target, of pieces of face information stored in the storage unit, in a case where a predetermined condition is satisfied; and performing face authentication using the feature quantity.

### BRIEF DESCRIPTION OF DRAWINGS

FIG. 1 is a block diagram illustrating a configuration of an information processing system according to a first example embodiment.

FIG. 2 is a block diagram illustrating a configuration of an information processing system according to a second example embodiment.

FIG. 3 is a flowchart illustrating a flow of an information processing operation of the information processing system according to the second example embodiment.

FIG. 4 is a conceptual diagram of the information processing operation of the information processing system according to the second example embodiment.

FIG. 5 is a conceptual diagram of an information processing system according to a third example embodiment.

FIG. 6 is a block diagram illustrating a configuration of the information processing system according to the third example embodiment.

FIG. 7 is a flowchart illustrating a flow of an information processing operation of the information processing system according to the third example embodiment.

FIG. 8 is a conceptual diagram of the information processing operation of the information processing system according to the third example embodiment.

FIG. 9 is a block diagram illustrating a configuration of an information processing system according to a fourth example embodiment.

FIG. 10 is a flowchart illustrating a flow of an information processing operation of the information processing system according to the fourth example embodiment.

### DESCRIPTION OF EXAMPLE EMBODIMENTS

Hereinafter, an information processing system, an information processing method, and a recording medium will be described with reference to the drawings.

### 1: First Example Embodiment

An information processing system, an information processing method, and a recording medium according to a first example embodiment will be described. The following describes the information processing system, the information processing method, and the recording medium according to the first example embodiment, by using an information processing system S1 to which the information processing system, the information processing method, and the recording medium according to the first example embodiment are applied.

### 1-1: Configuration of Information Processing System S1

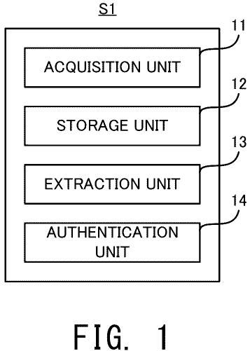

FIG. 1 is a block diagram illustrating a configuration of the information processing system S1 according to the first example embodiment. As illustrated in FIG. 1, the information processing system S1 includes an acquisition unit 11, a storage unit 12, an extraction unit 13, and an authentication unit 14.

The acquisition unit 11 sequentially acquires face information on a face area detected from captured images sequentially captured. The storage unit 12 sequentially stores the acquired face information. When a predetermined condition is satisfied, the extraction unit 13 performs an extraction operation of extracting a feature quantity from each piece of face information that is at least a part serving as an extraction target, of pieces of face information stored in the storage unit 12. The authentication unit 14 performs face authentication by using the feature quantity.

### 1-2: Technical Effect of Information Processing System S1

The information processing system S1 according to the first example embodiment extracts the feature quantity from each piece of face information that is at least a part serving as the extraction target, of the pieces of face information stored in the storage unit 12, when the predetermined condition is satisfied. That is, it is possible to perform batch processing of a large amount of face information by temporarily accumulating the face information in the storage unit 12 before the extraction operation. Thus, it is possible to increase the number of extracted feature quantities per time, and to increase throughput.

### 2: Second Example Embodiment

Next, an information processing system, an information processing method, and a recording medium according to a second example embodiment will be described. The following describes the information processing system, the information processing method, and the recording medium according to the second example embodiment, by using an information processing system S2 to which the information processing system, the information processing method, and the recording medium according to the second example embodiment are applied.

The information processing system S2 according to the second example embodiment may be applied to a scene in which a plurality of the target persons P need to be authenticated one after another.

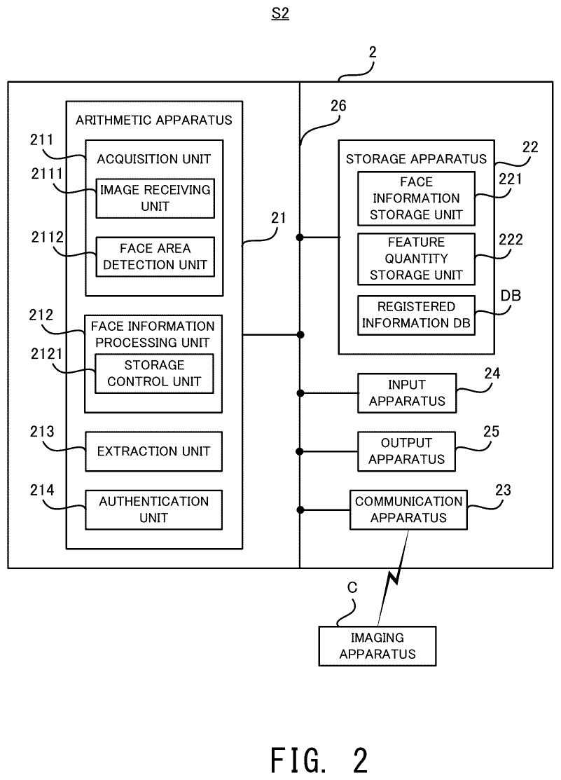

FIG. 2 is a block diagram illustrating the information processing system S2 according to the second example embodiment. As illustrated in FIG. 2, the information processing system S2 according to the second example embodiment may include an information processing apparatus 2 and an imaging apparatus C.

### 2-1: Configuration of Information Processing Apparatus 2

As illustrated in FIG. 2, the information processing apparatus 2 includes an arithmetic apparatus 21 and a storage apparatus 22. Furthermore, the information processing apparatus 2 may include a communication apparatus 23, an input apparatus 24, and an output apparatus 25. The information processing apparatus 2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected through a data bus 26.

The arithmetic apparatus 21 includes at least GPU (Graphics Processing Unit). The arithmetic apparatus 21 may further include at least one of, for example, a CPU (Central Processing Unit) and a FPGA (Field Programmable Gate Array). The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information processing apparatus 2 (e.g., the input apparatus 24 described later). The arithmetic apparatus 21 may acquire (i.e., download or read) a computer program from a not-illustrated apparatus disposed outside the information processing apparatus 2, through the communication apparatus 23 (or another communication apparatus). The arithmetic apparatus 21 executes the read computer program. Consequently, a logical functional block for performing an operation to be performed by the information processing apparatus 2 is realized or implemented in the arithmetic apparatus 21. That is, the arithmetic apparatus 21 is allowed to function as a controller for realizing or implementing the logical functional block for performing an operation (in other words, processing) to be performed by the information processing apparatus 2.

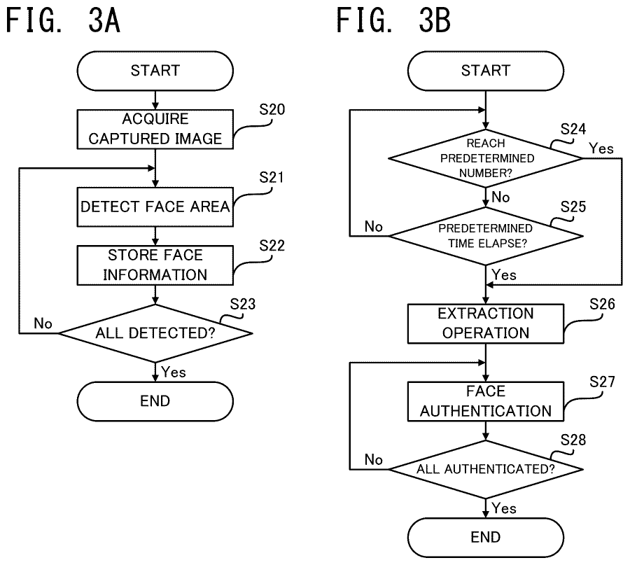

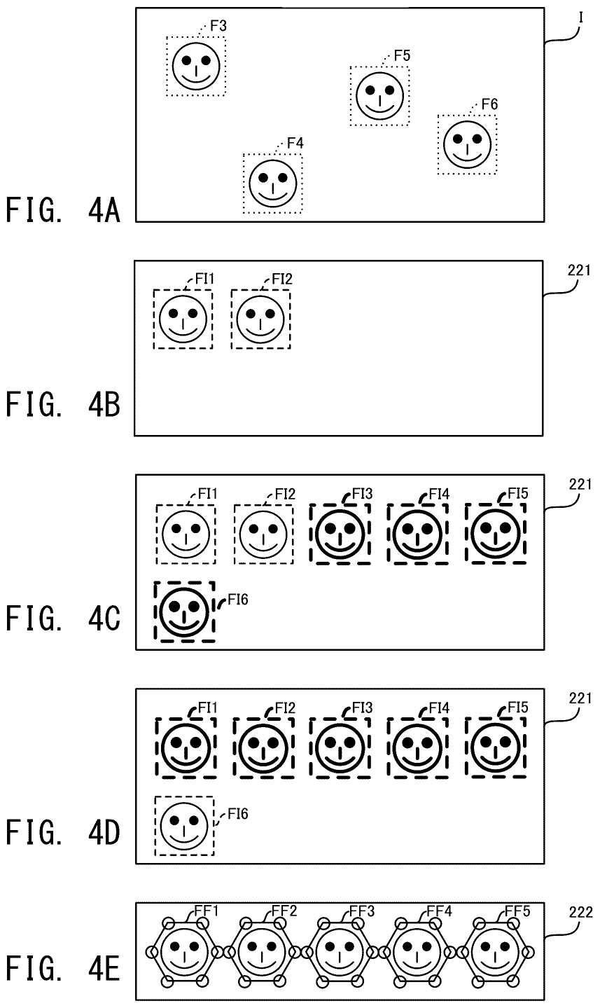

FIG. 2 illustrates an example of the logical functional block realized or implemented in the arithmetic apparatus 21 to perform an information processing operation. As illustrated in FIG. 2, an acquisition unit 211 that is a specific example of the “acquisition unit” described in Supplementary Note later, a face information processing unit 212, an extraction unit 213 that is a specific example of the “extraction unit” described in Supplementary Note later, and an authentication unit 214 that is a specific example of the “authentication unit” described in Supplementary Note later, are realized or implemented in the arithmetic apparatus 21. The acquisition unit 211 may include an image receiving unit 2111 and a face area detection unit 2112. The face information processing unit 212 may include a storage control unit 2121. Detailed operation of each of the image receiving unit 2111, the face area detection unit 2112, the storage control unit 2121, the extraction unit 213, and the authentication unit 214 will be described later with reference to FIG. 3 and FIG. 4.

The storage apparatus 22 is configured to store desired data. For example, the storage apparatus 22 may temporarily store a computer program to be executed by arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the information processing apparatus 2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium. The storage apparatus 22 may include a face information storage unit 221 that is a specific example of the “storage unit” described in Supplementary Note later, a feature quantity storage unit 222, and a registered information database DB. The storage apparatus 22, however, may not include at least one of the face information storage unit 221, the feature quantity storage unit 222, and the registered information database DB. In this instance, at least one of the face information storage unit 221, the feature quantity storage unit 222, and the registered information database DB may be realized or implemented in another apparatus.

The communication apparatus 23 is configured to communicate with an apparatus external to the information processing apparatus 2 through a not-illustrated communication network. The information processing apparatus 2 may transmit and receive signals to and from the imaging apparatus C through the communication apparatus 23.

The input apparatus 24 is an apparatus that receives an input of information to the information processing apparatus 2 from an outside of the information processing apparatus 2. For example, the input apparatus 24 may include an operating apparatus (e.g., at least one of a keyboard, a mouse, and a touch panel) that is operable by an operator of the information processing apparatus 2. For example, the input apparatus 24 may include a reading apparatus that is configured to read information recorded as data a recording medium that is externally attachable to the information processing apparatus 2.

The output apparatus 25 is an apparatus that outputs information to the outside of the information processing apparatus 2. For example, the output apparatus 25 may output information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a print apparatus (a so-called printer) that is configured to print desired information on the paper surface.

### 2-2: Information Processing Operation Performed by Information Processing System S2

Next, an information processing operation performed by the information processing system S2 according to the second example embodiment will be described with reference to FIG. 3 and FIG. 4. FIG. 3 is a flowchart illustrating a flow of the information processing operation performed by the information processing system S2 according to the second example embodiment. FIG. 3(a) illustrates a flow of a storage operation of storing face information FI, and FIG. 3(b) illustrates a flow of an extraction operation and an authentication operation. The storage operation of storing the face informational FI illustrated in FIG. 3(a) and the extraction operation and the face authentication operation illustrated in FIG. 3(b) may be performed in parallel. FIG. 4 is a conceptual diagram of the information processing operation performed by the information processing system S2 according to the second example embodiment.

As illustrated in FIG. 3(a), the image receiving unit 2111 acquires a captured image I (step S20). The imaging apparatus C may sequentially capture the captured image I. The image receiving unit 2111 acquires the captured images I sequentially captured, from the imaging apparatus C through the communication apparatus 23.

Although the image receiving unit 2111 sequentially acquires the captured images I from the imaging apparatus C, the operation from “start” to “end” illustrated in FIG. 3(a) may be an operation regarding one captured image I. For example, when the imaging apparatus C images a video, the operation from “start” to “end” illustrated in FIG. 3(a) may be the operation for each frame.

The face area detection unit 2112 detects a face area F from the captured image I (step S21). The face area detection unit 2112 receives the captured image I from the image receiving unit 2111, and detects the face area F included in the captured image I. For example, when the image receiving unit 2111 acquires the captured image I illustrated in FIG. 4(a), the face area detection unit 2112 may detect a face area F3, a face area F4, a face area F5, and a face area F6.

The storage control unit 2121 sequentially acquires the face information FI on the detected face area F, and sequentially stores it in the face information storage unit 221 (step S22). The face information storage unit 221 may be a storage unit that temporarily accumulates each piece of face information FI before batch processing by the extraction unit 213 described later. The face information FI may include a face image in the face area F that is cut out from the captured image I. For example, in a case where the face information storage unit 221 stores face information FI1 and face information FI2 as illustrated in FIG. 4(b), when the image receiving unit 2111 acquires the captured image I illustrated in FIG. 4(a), the storage control unit 2121 may sequentially store face information FI3, face information FI4, face information FI5, and face information FI6 in the face information storage unit 221, as illustrated in FIG. 4(c). In a case where the face information storage unit 221 stores the face information FI on the target person P corresponding to the detected face information FI, the storage control unit 2121 may delete the face information FI on the target person P in question stored in the face information storage unit 221. For example, in a case where the face information FI1 and the face information FI6 are face information on the same person, the storage control unit 2121 may delete the face information FI1 from the face information storage unit 221. That is, the storage control unit 2121 may discard the old face information FI in order to store the latest face information FI for the same person. The storage control unit 2121 may determine whether it is the face information FI on the same person, for example, by using a technique/technology of a face tracking function or the like.

The face area detection unit 2112 determines whether or not all the face areas F are detected (step S23). When all the face areas F are detected (the step S23: Yes), the operation regarding one captured image I is ended. When all the face area F are not detected (the step S23: No), the flow returns to the step S21. That is, when the captured image I includes a plurality of face areas F, the face area detection unit 2112 may detect all the face areas F.

As illustrated in FIG. 3(b), it is determined whether or not the number of pieces of face information FI stored in the face information storage unit 221 reaches a predetermined number (step S24). The face information processing unit 212 determines whether the predetermined number of pieces of face information FI are accumulated in the face information storage unit 221. When the number of pieces of face information FI stored in the face information storage unit 221 reaches the predetermined number (the step S24: Yes), the flow proceeds to step S26.

When the number of pieces of face information FI stored in the face information storage unit 221 does not reach the predetermined number (the step S24: No), the face information processing unit 212 determines whether or not a predetermined time elapses from a previous extraction operation by the extraction unit 213 (step S25). When the predetermined time does not elapse from the previous extraction operation by the extraction unit 213 (the step S25: No), the flow returns to the step S24.

When the predetermined time elapses from the previous extraction operation by the extraction unit 213 (the step S25: Yes), the flow proceeds to the step S26. That is, in at least one of the cases where the number of pieces of face information FI stored in the face information storage unit 221 reaches the predetermined number, and where the predetermined time elapses from the previous extraction operation by the extraction unit 213, the flow proceeds to the step S26. In other words, the information processing system S2 waits for a lapse of the predetermined time when the predetermined number of pieces of face information FI are not accumulated, and then shifts the processing to the step S26.

When the predetermined condition is satisfied (the step S24: Yes, or the step S25: Yes), the face information processing unit 212 instructs the extraction unit 213 to perform the extraction operation. The face information processing unit 212 may collectively input pieces of face information FI that are at least a part serving as the extraction target, of the pieces of face information FI stored in the face information storage unit 221 in the extraction unit 213. The face information processing unit 212 may collectively input the predetermined number of pieces of face information FI. The face information processing unit 212 may instruct the extraction unit 213 to perform batch processing using a GPU resource.

The extraction unit 213 performs an extraction operation of extracting a feature quantity from each piece of face information FI that is at least a part serving as the extraction target, of the pieces of face information FI stored in the face information storage unit 221 (step S26). The extraction unit 213 may perform the extraction operation by using the GPU resource. The extraction unit 213 may receive a plurality of pieces of face information FI from the face information storage unit 221 through the face information processing unit 212, and collectively extract facial feature quantities FF from the face information FI by using the GPU resource. The facial feature quantities FF extracted by the extraction unit 213 may be stored in the feature quantity storage unit 222. The number of pieces of face information FI received by the extraction unit 213 from the face information storage unit 221 through the face information processing unit 212, may be a predetermined number. For example, when the predetermined number is “5”, the face information processing unit 212 may use the face information FI1, the face information FI2, the face information FI3, the face information FI4, and the face information FI5, as the face information FI that is at least a part serving as the extraction target, of the pieces of face information FI stored in the face information storage unit 221, as illustrated in FIG. 4(d). In this case, by the extraction operation of the extraction unit 213, as illustrated in FIG. 4(e), the feature quantity storage unit 222 may store a facial feature quantity FF1, a facial feature quantity FF2, a facial feature quantity FF3, a facial feature quantity FF4, and a facial feature quantity FF5 collectively extracted. Here, the facial feature quantity FF1 may be a facial feature quantity FF extracted from a face image included in the face information FI1, the facial feature quantity FF2 may be a facial feature quantity FF extracted from a face image included in the face information FI2, the facial feature quantity FF3 may be a facial feature quantity FF extracted from a face image included in the face information FI3, the facial feature quantity FF4 may be a facial feature quantity FF extracted from a face image included in the face information FI4, and the facial feature quantity FF5 may be a facial feature quantity extracted from a face image included in the face information FI5. In addition, when the extraction operation is performed, the storage control unit 2121 may perform a deletion operation of deleting each piece of face information FI serving as the extraction target stored in the face information storage unit 221.

The authentication unit 214 performs face authentication using the facial feature quantity FF (step S27). The authentication unit 214 may sequentially acquire the facial feature quantity FF from the feature quantity storage unit 222. The authentication unit 214 may perform the face authentication by collating/verifying the facial feature quantity FF stored in the feature quantity storage unit 222 with information registered in the registered information database DB. For example, when the information processing system S2 according to the second example embodiment is applied to an opening/closing control of a gate, the gate may be sequentially opened in response to a success in the authentication.

The authentication unit 214 determines whether or not the face authentication regarding all the extracted facial feature quantities FF is performed (step S28). When the face authentication regarding all the extracted facial feature quantities FF is performed (the step S28: Yes), the operation when the predetermined condition is satisfied (the step S24 or the step S25: Yes) is ended. When the face authentication regarding all the extracted facial feature quantities FF is not performed (the step S28: No), the flow returns to the step S27. That is, when a plurality of facial feature quantity FF are extracted in the step S26, the authentication unit 214 sequentially performs the face authentication on all the facial feature quantities FF.

Although the extraction unit 213 performs the extraction operation by using the GPU resource, at least one of the acquisition unit 211, the face information processing unit 212, and the authentication unit 214 may also perform the operation by using the GPU resource. At least one of the acquisition unit 211, the face information processing unit 212, and the authentication unit 214 may perform the operation by using at least one of the GPU resource, a CPU resource, and a FPGA resource.

### 2-4: Technical Effect of Information Processing System S2

The information processing system S2 according to the second example embodiment extracts the feature quantity from each piece of face information FI that is at least a part serving as the extraction target, of the pieces of face information FI stored in the face information storage unit 221, in at least one of the cases where the number of pieces of face information FI stored in the face information storage unit 221 reaches the predetermined number, and where the predetermined time elapses from the previous extraction operation by the extraction unit 213. In addition, since the extraction unit 213 uses the GPU resource for the extraction operation, it is possible to perform the batch processing on many pieces of face information FI. That is, since the face information FI is temporarily accumulated in the face information storage unit 221 before the extraction operation by the extraction unit 213, it is possible to perform the batch processing on many pieces of face information FI. This increases the number of processing by a single extraction operation and the number of processing per hour, thereby achieving high-throughput. In addition, since an extraction processing time per case is reduced, it is possible to reduce a waiting time for the target person P to be authenticated, thereby achieving a short response.

In an apparatus that performs the authentication, as compared with a case where the extraction operation of extracting the facial feature quantity FF is performed by using the CPU resource, a total cost may be reduced when the extraction operation of extracting the facial feature quantity FF is performed by using the GPU resource.

### 3: Third Example Embodiment

Next, an information processing system, an information processing method, and a recording medium according to a third example embodiment will be described. The following describes the information processing system, the information processing method, and the recording medium according to the third example embodiment, by using an information processing system S3 to which the information processing system, the information processing method, and the recording medium according to the third example embodiment are applied.

The information processing system S3 according to the third example embodiment may be applied not only to a scene in which a plurality of the target persons P need to be authenticated one after another, but also to a scene in which it is unknown from which target person P the authentication starts to be performed until just before, and a scene in which authenticate order is replaced.

Hereinafter, the third example embodiment will exemplify and describe a case where an authentication result by the information processing system S3 is applied to an opening/closing control of a gate apparatus G through which the target person P may pass.

### 3-1: Overall Configuration of Information Processing System S3

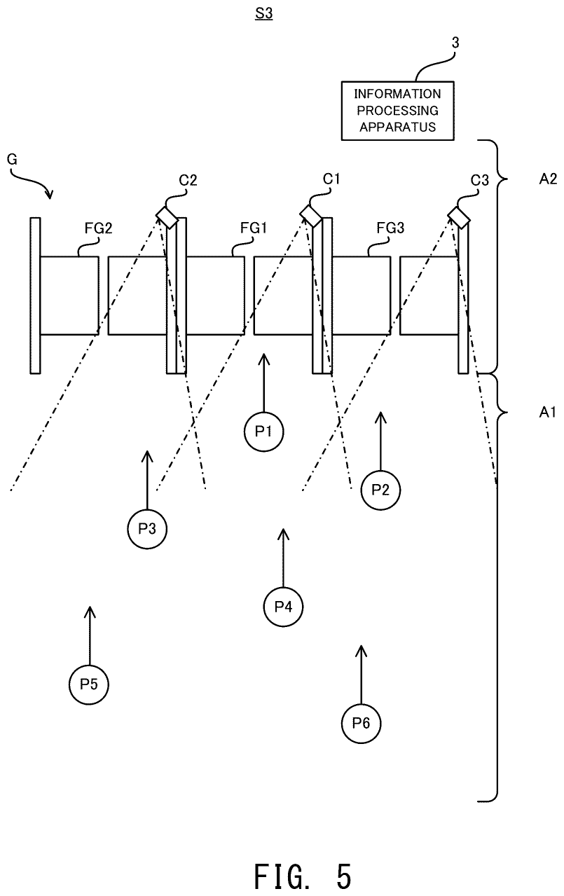

FIG. 5 is a conceptual diagram of the information processing system S3 according to the third example embodiment. As illustrated in FIG. 5, the information processing system S3 according to the third example embodiment may include an information processing apparatus 3 and the imaging apparatus C.

The gate apparatus G is an apparatus that is configured to control the passage of a target person P1, a target person P2, a target person P3, a target person P4, a target person P5, and a target person P6 (referred to as the target person P when no distinction is made). The gate apparatus G may be opened or closed according to the authentication result by the information processing system S3. The gate apparatus G may include a plurality of flapper gates FG. The target person P may be able to pass through at least one of the plurality of flapper gates FG. The imaging apparatus C may be provided for each flapper gate FG. For example, an imaging apparatus C1 provided in the vicinity of a flapper gate FG1 may be capable of imaging the vicinity of the flapper gate FG1. Furthermore, an imaging apparatus C2 provided in the vicinity of a flapper gate FG2 may be capable of imaging the vicinity of the flapper gate FG2. In addition, an imaging apparatus C3 provided in the vicinity of a flapper gate FG3 may be capable of imaging the vicinity of the flapper gate FG3. A distance between the imaging apparatus C and the target person P may correspond to a distance between the flapper gate FG and the target person P.

A second area A2 is a moving destination of the target person P, and may be an area where only the authenticated target person P is allowed to enter. For the authenticated target person P, the flapper gate FG is controlled to be opened, and the target person P may move from a first area A1 to the second area A2 through the flapper gate FG.

The flapper gate FG is a member that is configured to control the passage of the target person P. As the flapper gate FG, a plate-shaped member is illustrated, but a rod-shaped member may be also used. A state of the flapper gate FG may be controlled by the information processing apparatus 3 on the basis of an information processing results of the target person P by the information processing apparatus 3. Specifically, when the authentication of the target person P by the information processing apparatus 3 is successful (i.e., when the target person P is determined to match a registered person), the state of the flapper gate FG may be controlled by the information processing apparatus 3 into an open state where the target person P may pass through the flapper gate FG. The registered person may be, for example, a person permitted to enter the second area A2. On the other hand, when the authentication of the target person P by the information processing apparatus 3 is failed (i.e., when the target person P is determined not to match the registered person), the state of the flapper gate FG may be controlled by the information processing apparatus 3 into a closed state where the target person P cannot pass through the flapper gate FG.

### 3-2: Configuration of Information Processing System S3

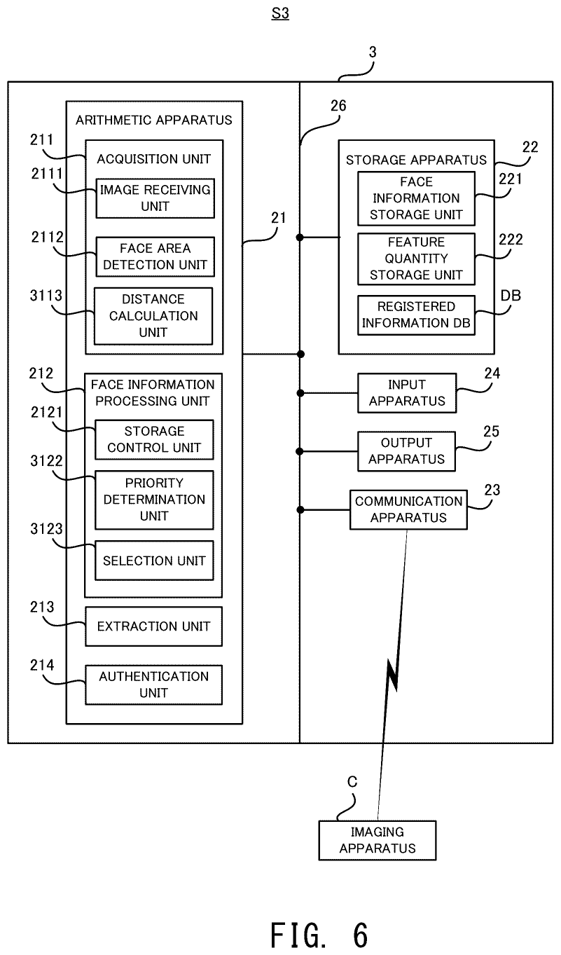

With reference to FIG. 6, a configuration of the information processing system S3 according to the third example embodiment will be described. FIG. 6 is a block diagram illustrating the configuration of the information processing system S3 according to the third example embodiment. As illustrated in FIG. 6, the information processing system S3 according to the third example embodiment may include the information processing apparatus 3 and the imaging apparatus C, as in the information processing system S2 according to the second example embodiment.

As illustrated in FIG. 6, the information processing apparatus 3 according to the third example embodiment includes the arithmetic apparatus 21 and the storage apparatus 22, as in the information processing apparatus 2 according to the second example embodiment. Furthermore, the information processing apparatus 3 according to the third example embodiment may include the communication apparatus 23, the input apparatus 24, and the output apparatus 25, as in the information processing apparatus 2 according to the second example embodiment. The information processing apparatus 3, however, may not include at least one of the communication apparatus 23, the input apparatus 24, and the output apparatus 25. The information processing apparatus 3 according to the third example embodiment is different from the information processing apparatus 2 according to the second example embodiment, in that the acquisition unit 211 provided in the arithmetic apparatus 21 further includes a distance calculation unit 3113, and that the face information processing unit 212 provided in the arithmetic apparatus 21 further includes a priority determination unit 3122 and a selection unit 3123. Other features of the information processing apparatus 3 may be the same as those of the information processing apparatus 2 according to the second example embodiment. For this reason, a part that is different from each of the example embodiments described above will be described in detail below, and a description of the other overlapping parts will be omitted as appropriate.

### 3-3: Information Processing Operation Performed by Information Processing System S3

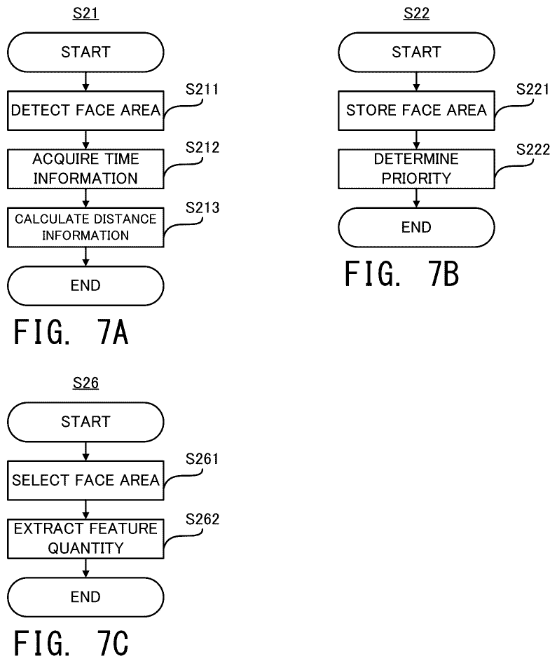

As illustrated in FIG. 7, an information processing operation performed by the information processing system S3 is different in the step S21, the step S22, and the step S26 from the information processing operation performed by the information processing system S2 illustrated in FIG. 3.

As illustrated in FIG. 7(a), in the step S21, the face area detection unit 2112 detects the face area F from the captured image I (step S211). The face area detection unit 2112 may detect the face area F in descending order of size, among the face areas F included in the captured image I.

The face area detection unit 2112 acquires time information indicating a time regarding the detection of the face area F (step S212). The time is, for example, a time point, or a date and time, and the time information is, for example, time point information, or date and time information. The face area detection unit 2112 may detect a time when the face area F is detected from the captured image I. Alternatively, the face area detection unit 2112 may detect a time when the captured image I is acquired. Alternatively, the face area detection unit 2112 may detect a time when the captured image I is captured.

The distance calculation unit 3113 calculates distance information (step S213). The distance information is information indicating a distance from a location for sequential imaging to a location of the face area F. That is, the distance calculation unit 3113 calculates the distance between the imaging apparatus C and the target person P corresponding to the face area F. The distance calculation unit 3113 may calculate the distance between the imaging apparatus C and the target person P, from a size of the face area F, a distance between eyes included in the face area F, a result of comparison in size with a comparison target in the captured image I, or the like. The distance calculation unit 3113 may calculate the distance between the imaging apparatus C and the target person P by a measurement result by a distance measuring sensor.

In the third example embodiment, the face information FI may include at least the face image of the face area F, the time information, and the distance information. The time information and the distance information may be referred to as meta information.

As illustrated in FIG. 7(b), in the step S22, the storage control unit 2121 controls the face information storage unit 221 to store therein the face information FI (step S221). That is, the storage control unit 2121 controls the face information storage unit 221 to store therein the time information and the distance information in association with the face image. The storage control unit 2121 may control the face information storage unit 221 to store therein pieces of face information FI on the same target person P detected from the captured images I captured by the plurality of imaging apparatuses C in association with each other.

The priority determination unit 3122 determines priority of the face information FI stored in the face information storage unit 221 according to the time information and the distance information (step S222). The prioritization unit 3122 may determine whether or not the target person P corresponding to the face information FI newly stored in the face information storage unit 221 is closer to the imaging apparatus C than the target person P corresponding to the accumulated face information FI is, according to the time information and the distance information. The priority determination unit 3122 may increase the priority of the new face information FI when determining that the target person P corresponding to the new face information FI is closer to the imaging apparatus C than the target person P corresponding to the accumulated face information FI is.

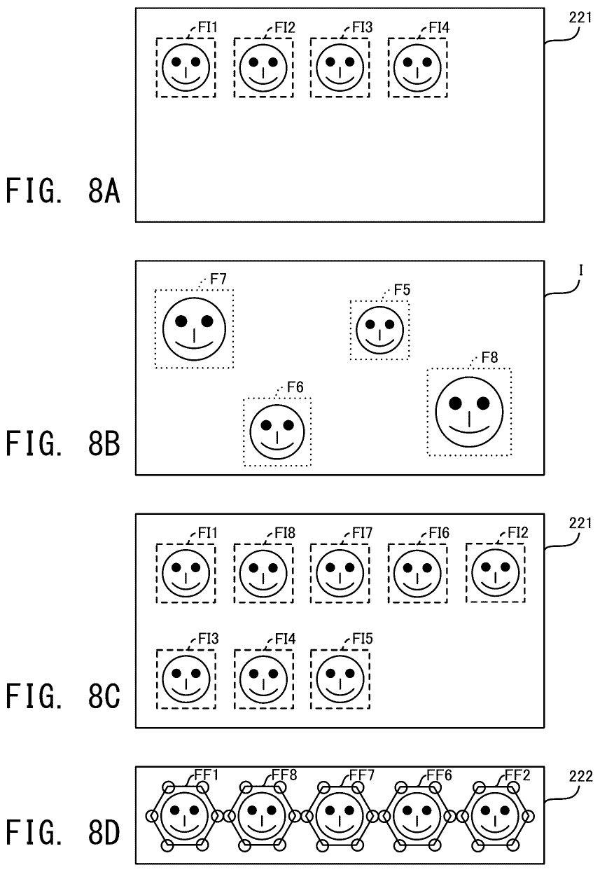

For example, the following case will be described; namely, the face information storage unit 221 accumulates face information FI1, face information FI2, face information FI3, and face information FI4, as illustrated in FIG. 8(a), and the image receiving unit 2111 acquires the captured image I including a face area F5, a face area F6, a face area F7, and a face area F8 illustrated in FIG. 8(b). It is assumed that the face information FI1, the face information FI2, the face information FI3, and the face information FI4 are detected in order of the face information FI1, the face information FI2, the face information FI3, and the face information FI4. It is also assumed that the size of the face area F corresponding to the face information FI1, the face information FI2, the face information FI3, and the face information FI4 is equal to the size of the face area F5, that the face area F6 is greater than the face area F5, that the face area F7 is greater than the face area F6, and that the face area F8 is greater than the face area F7. In this instance, the priority determination unit 3122 may set the priority of face information FI8 corresponding to the face area F8, face information FI7 corresponding to the face area F7, and face information FI6 corresponding to the face area F6 to be lower than the priority of the face information FI1 detected earlier, and to be higher than the priority of the face information FI2, the face information FI3, and the face information FI4. In FIG. 8, the face information FI with higher priority may be positioned on an upper side and further to the left in the face information storage unit 221. That is, FIG. 8(c) may exemplify a case where descending order of the priority is the face information FI1, the face information FI8, the face information FI7, the face information FI6, the face information FI2, the face information FI3, the face information FI4, and the face information FI5.

As illustrated in FIG. 7(c), in the step S26, the selection unit 3123 selects the face information FI (step S261). The selection unit 3123 selects, based on the priority determined in the step S222, the face information FI to be included in the extraction target from the face information FI stored in the face information storage unit 221. For example, in the case illustrated in FIG. 8(c), the selection unit 3123 may select the face information FI1, the face information FI8, the face information FI7, the face information FI6, and the face information FI2 stored in the face information storage unit 221, as the extraction target.

The extraction unit 213 detects the facial feature quantity FF from each piece of face information FI selected by the selection unit 3123 in response to an instruction of the face information processing unit 212 (step S262). For example, as illustrated in FIG. 8(d), the feature quantity storage unit 222 may store a facial feature quantity FF1, a facial feature quantity FF8, a facial feature quantity FF7, a facial feature quantity FF6, and a facial feature quantity FF2 respectively extracted from the face information FI1, the face information FI8, the face information FI7, the face information FI6, and the face information FI2.

After the step S26, as in the information processing operation in the second example embodiment, the authentication unit 214 performs face authentication processing using the facial feature quantity FF. When the authentication is successful, the information processing apparatus 3 may perform the opening control of the gate corresponding to the facial feature quantity FF in which the authentication is successful.

### 3-4: Technical Effect of Information Processing System S3

The information processing system S3 according to the third example embodiment increases the priority of the face information FI when the face information FI corresponding to the target person P who is close in distance to the imaging apparatus C is detected later, and sets it as a target of the extraction operation performed earlier. That is, the priority of the face informational FI corresponding to the target person P to be authenticated earlier is increased, so that the facial feature quantity FF is extracted earlier. This makes it possible to reduce a sensory time of the target person P from arrival at an authentication location to completion of the authentication. In a case where it is applied to the gate apparatus G, it is possible to reduce the sensory time of the target person P from the arrival at the gate to unlocking.

### 4: Fourth Example Embodiment

Next, an information processing system, an information processing method, and a recording medium according to a fourth example embodiment will be described. The following describes the information processing system, the information processing method, and the recording medium according to the fourth example embodiment, by using an information processing system S4 to which the information processing system, the information processing method, and the recording medium according to the fourth example embodiment are applied.

The information processing system S4 according to the fourth example embodiment may be applied to a scene in which a plurality of the target persons P need to be authenticated one after another and it is unknown from which target person P the authentication starts to be performed until just before, and a scene in which authenticate order is replaced, as in the information processing system S3 according to the third example embodiment.

Even in the fourth example embodiment, as in the information processing system S3 according to the third example embodiment, an authentication result by the information processing system S4 may be applied to the opening/closing control of the gate apparatus G through which the target person P may pass.

### 4-1: Configuration of Information Processing System S4

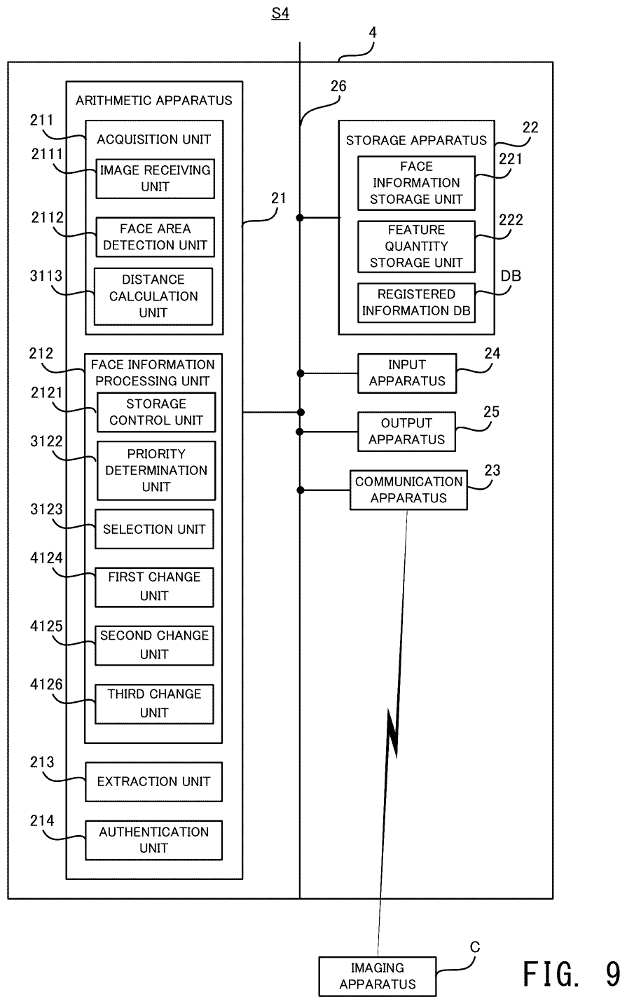

With reference to FIG. 9, a configuration of the information processing system S4 according to the fourth example embodiment will be described. FIG. 9 is a block diagram illustrating the configuration of the information processing system S4 according to the fourth example embodiment. As illustrated in FIG. 9, the information processing system S4 according to the fourth example embodiment may include an information processing apparatus 4 and the imaging apparatus C, as in the information processing system S2 according to the second example embodiment and the information processing system S3 according to the third example embodiment.

As illustrated in FIG. 9, the information processing apparatus 4 according to the fourth example embodiment includes the arithmetic apparatus 21 and the storage apparatus 22, as in the information processing apparatus 2 according to the second example embodiment and the information processing apparatus 3 according to the third example embodiment. Furthermore, the information processing apparatus 4 according to the fourth example embodiment may include the communication apparatus 23, the input apparatus 24, and the output apparatus 25, as in the information processing apparatus 2 according to the second example embodiment and the information processing apparatus 3 according to the third example embodiment. The information processing apparatus 4, however, may not include at least one of the communication apparatus 23, the input apparatus 24, and the output apparatus 25. The information processing apparatus 4 according to the fourth example embodiment is different from the information processing apparatus 2 according to the second example embodiment and the information processing apparatus 3 according to the third example embodiment, in that the face information processing unit 212 provided in the arithmetic apparatus 21 further includes a first change unit 4124, a second change unit 4125, and a third change unit 4126.

The first change unit 4124 changes the predetermined number according to a change rate of the number of the pieces of face information FI stored in the face information storage unit 221. The second changing unit 4125 changes the predetermined time according to a time from execution of the previous extraction operation by the extracting unit 213 until the number of the pieces of face information FI stored in the face information storage unit 221 reaches the predetermined number. The third change unit 4126 compares a time from start to completion of the extraction operation with the predetermined time, and changes an imaging interval corresponding to an imaging interval of sequential imaging.

Furthermore, in the fourth example embodiment, the predetermined number and the predetermined time are changed depending on a situation. Each of the predetermined number and the predetermined time has a settable lower limit and a settable upper limit.

Other features of the information processing apparatus 4 may be the same as those of the information processing apparatus 2 according to the second example embodiment or the information processing apparatus 3 according to the third example embodiment. For this reason, a part that is different from each of the example embodiments described above will be described in detail below, and a description of the other overlapping parts will be omitted as appropriate.

### 4-2: Information Processing Operation Performed by Information Processing System S4

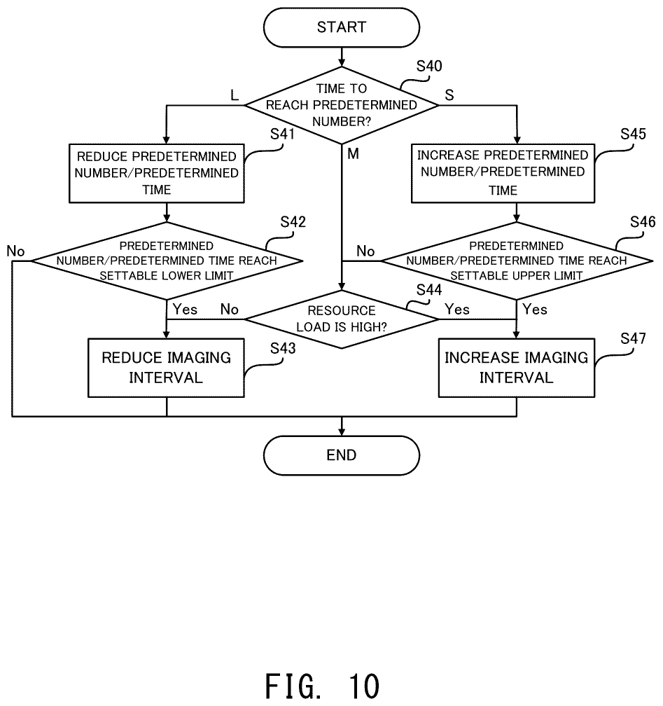

With reference to FIG. 10, an information processing operation performed by the information processing system S4 according to the fourth example embodiment will be described. FIG. 10 is a flowchart illustrating a flow of the information processing operation performed by the information processing system S4 according to the fourth example embodiment. The information processing operation illustrated in FIG. 10 may be an operation performed periodically in each predetermined period.

The face information processing unit 212 monitors the change rate of the number of the pieces of face information FI stored in the face information storage unit 221. Furthermore, the face information processing unit 212 monitors the time from the execution of the previous extraction operation by the extracting unit 213 until the number of the pieces of face information FI stored in the face information storage unit 221 reaches the predetermined number.

As illustrated in FIG. 10, the face information processing unit 212 determines whether the number of the pieces of face information FI stored in the face information storage unit 221 tends to reach the predetermined number in a short time, in a long time, or in a neither short nor long time (step S40). For example, the face information processing unit 212 may make a comparison with an average accumulation tendency of the face information FI for the last 5 minutes and may perform the determination.

When the number of the pieces of face information FI stored in the face information storage unit 221 tends to reach the predetermined number in a long time (the step S40: L), the first change unit 4124 reduces the predetermined number. Furthermore, the second change unit 4125 reduces the predetermined time (step S41). By reducing the predetermined number and reducing the predetermined time, it is possible to prevent a waiting time required to accumulate from being wasted.

The face information processing unit 212 may perform optimization by dynamically changing at least one of the predetermined number and the predetermined time so as to maintain a relation of the following equation.

(Time required to accumulate to predetermined number+α)<=Time until a lapse of predetermined time

That is, the optimization may be performed by dynamically changing the predetermined time such that a time difference between the time required to accumulate to the predetermined number and the time until a lapse of the predetermined time is within a certain range (a).

The face information processing unit 212 determines whether or not at least one of the predetermined number and the predetermined time reaches the settable lower limit (step S42). When at least one of the predetermined number and the predetermined period reaches the lower limit (the step S42: Yes), a total apparatus load is expected to be lower than assumed. Therefore, the third change unit 4126 changes the imaging interval to be short (step S43). The image receiving unit 2111 may gradually adjust the imaging interval of the imaging apparatus C to be the imaging interval changed by the third change unit 4126.

The third change unit 4126 compares the time from start to completion of the extraction operation with the predetermined time, and changes the imaging interval of sequential imaging. That is, the third change unit 4126 may compare the time corresponding to the predetermined number with the predetermined time, and may change the imaging interval of sequential imaging.

Furthermore, the third change unit 4126 may change the imaging interval of the imaging apparatus C according to congestion information corresponding to the imaging apparatus C. The face area detection unit 2112 may calculate the congestion information. The congestion information is information indicating a congestion level near the imaging apparatus C when the face information FI is detected. The face area detection unit 2112 may calculate the congestion information from the number of the detected face areas F included in the captured image I. The third change unit 4126 may preferentially change to be long the imaging interval of the imaging apparatus C which it is congested. In the congestion, the movement of the target person P is expected to be less, and an effect/influence by the increased imaging interval and a reduced frame rate is expected to be less. The load is reduced by increasing the imaging interval, and on the other hand, a delay is also reduced by prioritizing the processing of the face information FI from the distance between the target person P and the imaging apparatus C.

When at least one of the predetermined number and the predetermined time does not reach the lower limit (the step S42: No), the information processing operation illustrated in FIG. 10 is ended.

When the number of the pieces of face information FI stored in the face information storage unit 221 tends to reach the predetermined number in a short time, it can be determined that it is congested, and it is thus more efficient to increase the number of the pieces of face information FI for the batch processing with the GPU resource. Therefore, when the number of the pieces tends to reach the predetermined number in a short time (step S40: S), the first change unit 4124 increases the predetermined number. Furthermore, the second change unit 4125 increases the predetermined time (step S45). When the time to reach the predetermined number tends to be short, it can be determined that it is congested. Therefore, efficiency is increased by proceeding to the step S45, increasing the predetermined number and the predetermined time, and increasing the number of the pieces of face information FI for the batch processing.

The face information processing unit 212 determines whether or not at least one of the predetermined number and the predetermined time reaches the upper limit (step S46). When the upper limit is reached, the total apparatus load is expected to be higher than assumed. When at least one of the predetermined number and the predetermined time reaches the upper limit (the step S46: Yes), the third change unit 4126 increases the imaging interval (step S47). The third changing unit 4126 may instruct the imaging apparatus C to gradually increase the imaging interval. When at least one of the predetermined number and the predetermined time does not reach the upper limit (the step S46: No), the flow proceeds to step S44.

In the step S40, when the number of the pieces tends to reach the predetermined number in a neither short nor long time (the step S40: M), the face information processing unit 212 determines whether or not at least one of the GPU resource and the CPU resource is high (step S44). For example, a tendency in a usage rate of at least one of the GPU resource and the CPU resource may be compared with an average/mean value for the last 5 minutes, or the like.

When at least one of the GPU resource and the CPU resource is high (the step S44: Yes), the third changing unit 4126 changes the imaging interval to be long (step S47). The image receiving unit 2111 may gradually adjust the imaging interval of the imaging apparatus C to be the imaging interval changed by the third change unit 4126.

When at least one of the GPU resource and the CPU resource is not high (the step S44: No), the flow proceeds to the step S43.

The face information processing unit 212 periodically monitors the tendency of the number of the pieces of face information FI stored in the face information storage unit 221, and adjusts the predetermined number and the predetermined time according to a load state, in the face information storage unit 221 before the batch processing by the extraction unit 213. Thus, control is performed to achieve optimal throughput and response for an environment.

### 4-3: Technical Effect of Information Processing System S4

In the information processing system S4 according to the fourth example embodiment, since the first changing unit 4124 dynamically changes the predetermined number according to the load state, it is possible to control the throughput and the response to be optimal. When the first changing unit 4124 reduces the predetermined number, the extraction operation using the GPU resource may be started immediately. When the first changing unit 4124 increases the predetermined number, the extraction operation collectively performed by using the GPU resource is more effectively utilized. Since the second changing unit 4125 dynamically changes the predetermined time according to the load state, it is possible to control the throughput and the response to be optimal. Since the third changing unit 4126 dynamically changes the imaging interval according to the load state, it is possible to control the throughput and the response to be optimal. In particular, when the imaging interval is increased, depending on timing of detecting the face area F in the face area detection unit 2112, there is a large variation in the distance between the target person P and the imaging apparatus C. Therefore, the change in the imaging interval has an excellent effect in a case where the priority is replaced such that, when the face information FI corresponding to the target person P who is close in distance to the imaging apparatus C is stored later in the face information storage unit 221, the face information FI is processed earlier in the face information processing unit 212, as in the third example embodiment. In particular, it is effective when the number of the pieces of face information FI stored in the face information storage unit 221 exceeds the predetermined number of target pieces for GPU resource batch processing.

### 5: Supplementary Notes

With respect to the example embodiment described above, the following Supplementary Notes are further disclosed.

### Supplementary Note 1

An information processing system including:
an acquisition unit that sequentially acquires face information on a face area detected from captured images sequentially captured;
a storage unit that sequentially stores the acquired face information;
an extraction unit that performs an extraction operation of extracting a feature quantity from each piece of face information that is at least a part serving as an extraction target, of pieces of face information stored in the storage unit, in a case where a predetermined condition is satisfied; and
an authentication unit that performs face authentication using the feature quantity.

### Supplementary Note 2

The information processing system according to Supplementary Note 1, wherein
the extraction unit uses a GPU resource for the extraction operation, and
the face information includes a face image in the face area.

### Supplementary Note 3

The information processing system according to Supplementary Note 1 or 2, wherein the case where the predetermined condition is satisfied, includes at least one of a case where number of the pieces of face information stored in the storage unit reaches a predetermined number, and a case where a predetermined time elapses from a previous extraction operation by the extraction unit.

### Supplementary Note 4

The information processing system according to Supplementary Note 3, further including a first change unit that changes the predetermined number according to a change rate of the number of the pieces of face information stored in the storage unit.

### Supplementary Note 5

The information processing system according to Supplementary Note 3, further including a second change unit that changes the predetermined time according to a time from execution of the previous extraction operation by the extraction unit until the number of the pieces of face information stored in the storage unit reaches the predetermined number.

### Supplementary Note 6

The information processing system according to Supplementary Note 3, further including a third change unit that compares a time from start to completion of the extraction operation with the predetermined time, and that changes an imaging interval of sequential imaging.

### Supplementary Note 7

The information processing system according to Supplementary Note 6, wherein the face information includes a face image in the face area, time information indicating a time regarding detection of the face area, and distance information indicating a distance from a location for the sequential imaging to a location of the face area, and
the information processing system further includes a face information processing unit that determines priority of the pieces of face information stored in the storage unit, according to the time information and the distance information, and that selects a piece of face information to be included in the extraction target, from the pieces of face information stored in the storage unit, based on the priority.

### Supplementary Note 8

An information processing method including:
sequentially acquiring face information on a face area detected from captured images sequentially captured;
sequentially storing the acquired face information in a storage unit;
performing an extraction operation of extracting a feature quantity from each piece of face information that is at least a part serving as an extraction target, of pieces of face information stored in the storage unit, in a case where a predetermined condition is satisfied; and
performing face authentication using the feature quantity.

### Supplementary Note 9

A recording medium on which a computer program that allows a computer to execute an information processing method is recorded, the information processing method including:
sequentially acquiring face information on a face area detected from captured images sequentially captured;
sequentially storing the acquired face information in a storage unit;
performing an extraction operation of extracting a feature quantity from each piece of face information that is at least a part serving as an extraction target, of pieces of face information stored in the storage unit, in a case where a predetermined condition is satisfied; and
performing face authentication using the feature quantity.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, all references cited in the disclosure (e.g., published publications) are hereby incorporated by reference, as a part of the description of this disclosure.

This disclosure is allowed to be changed, if desired, without departing from the essence or spirit of this disclosure which can be read from the claims and the entire identification. An information processing system, an information processing method, and a recording medium with such changes are also intended to be within the technical scope of this disclosure.

### DESCRIPTION OF REFERENCE CODES

S1, S2, S3, S4 Information processing system
2, 3, 4 Information processing apparatus
11, 211 Acquisition unit
2111 Image receiving unit
2112 Face area detection unit
12 Storage unit
212 Face information processing unit
2121 Storage control unit
221 Face information storage unit
222 Feature quantity storage unit
13,213 Extraction unit
14,214 Authentication unit
3113 Distance calculation unit
3122 Priority determination unit
3123 Selection unit
4124 First change unit
4125 Second change unit
4126 Third change unit
C Imaging apparatus
I Captured image
F Face area
FI face information
FF facial feature quant

What is claimed is:

1. An information processing system comprising:
at least one first memory that is configured to store instructions; and
at least one processor that is configured to execute the instructions to:
sequentially acquires face information on a face area detected from captured images sequentially captured;
sequentially store the acquired face information in a second memory;
perform an extraction operation of extracting a feature quantity from each piece of face information that is at least a part serving as an extraction target, of pieces of face information stored in the second memory, in a case where a predetermined condition is satisfied; and
perform face authentication using the feature quantity.

2. The information processing system according to claim 1, wherein
the at least one processor uses a GPU resource for the extraction operation, and
the face information includes a face image in the face area.

3. The information processing system according to claim 1, wherein the case where the predetermined condition is satisfied, includes at least one of a case where number of the pieces of face information stored in the second memory reaches a predetermined number, and a case where a predetermined time elapses from a previous extraction operation.

4. The information processing system according to claim 3, wherein the at least one processor is configured to execute the instructions to change the predetermined number according to a change rate of the number of the pieces of face information stored in the second memory.

5. The information processing system according to claim 3, wherein the at least one processor is configured to execute the instructions to change the predetermined time according to a time from execution of the previous extraction operation until the number of the pieces of face information stored in the second memory reaches the predetermined number.

6. The information processing system according to claim 3, wherein the at least one processor is configured to execute the instructions to: compare a time from start to completion of the extraction operation with the predetermined time, and change an imaging interval of sequential imaging.

7. The information processing system according to claim 6, wherein
the face information includes a face image in the face area, time information indicating a time regarding detection of the face area, and distance information indicating a distance from a location for the sequential imaging to a location of the face area, and
the at least one processor is configured to execute the instructions to: determine priority of the pieces of face information stored in the second memory, according to the time information and the distance information, and select a piece of face information to be included in the extraction target, from the pieces of face information stored in the second memory, based on the priority.

8. An information processing method comprising:
sequentially acquiring face information on a face area detected from captured images sequentially captured;
sequentially storing the acquired face information in a memory;
performing an extraction operation of extracting a feature quantity from each piece of face information that is at least a part serving as an extraction target, of pieces of face information stored in the memory, in a case where a predetermined condition is satisfied; and
performing face authentication using the feature quantity.

9. A non-transitory recording medium on which a computer program that allows a computer to execute an information processing method is recorded, the information processing method including:
sequentially acquiring face information on a face area detected from captured images sequentially captured;
sequentially storing the acquired face information in a memory;
performing an extraction operation of extracting a feature quantity from each piece of face information that is at least a part serving as an extraction target, of pieces of face information stored in the memory, in a case where a predetermined condition is satisfied; and
performing face authentication using the feature quantity.
